(19) United States
(12) Patent Application Publication
(10) Pub. No.: US 2007/0240302 A1
(43) Pub. Date: Oct. 18, 2007

(54) Device for feeding workpieces to a rotary table

(75) Inventors: Marc Schabert, Schoenbuehl-Urtenen (CH); Roman Angst, Zuerich (CH)

Correspondence Address: BIRCH STEWART KOLASCH & BIRCH, PO BOX 747, FALLS CHURCH, VA, 22040-0747, US

(73) Assignee: Packsys Global (Switzerland) Ltd., Oberburg (CH)

(21) Appl. No.: 11/714,128

(22) Filed: Mar. 6, 2007

(30) Foreign Application Priority Data
Mar. 7, 2006 (EP) 06 405 098.2

(51) Int. Cl. B23P 21/00

(52) U.S. Cl. 29/785

(57) ABSTRACT

A device for feeding workpieces to a rotary table includes a loading star which rotates about an axis which is parallel to the axis of the rotary table. Workpieces which are held in successive receptacles in the loading star can be successively transferred into corresponding receptacles in the rotary table. A similar rotary unloading star having receptacles therein may be provided for removing workpieces from the rotary table.

### TECHNICAL FIELD

The invention relates to a device for feeding workpieces to a rotary table, which can rotate about a first axis, of a machining device, comprising a loading star which can rotate about a second axis which is parallel to the first axis, has circumferential receptacles for the workpieces and is embodied and can be arranged in such a way that given simultaneous, synchronized rotary movement of the loading star and of the rotary table, workpieces which are held in successive receptacles in the loading star can be successively transferred into corresponding receptacles in the rotary table. The invention also relates to a device for transporting away workpieces from one rotary table, which can rotate about a first axis, of a machining device, comprising an unloading star which can rotate about the second axis parallel to the first axis, has circumferential receptacles for the workpieces and is embodied, and can be arranged, in such a way that given simultaneous, synchronized rotary movement of the rotary table and of the unloading star, workpieces which are held in successive receptacles in the rotary table can be transferred successively into corresponding receptacles in the unloading star. The invention finally relates to a machining arrangement having a device for feeding workpieces, a machining station and a device for transporting away workpieces.

### PRIOR ART

Machining devices with rotary tables are known and have a wide range of application. The rotary table can hold a plurality of workpieces along its circumference. By the incremental or continuous rotation of the rotary table, the workpieces are moved through one workstation which is extended along the circumference or a plurality of workstations which are arranged one behind the other, at which workstations machining processes take place. After the machining, the workpieces are removed from the rotary table again. In this way, a plurality of workpieces which are held by the rotary table can be machined simultaneously, which permits high production speeds.

Solutions for charging the rotary table with workpieces are known in which a loading star which can rotate about a vertical axis and has circumferential receptacles is arranged adjacent to the rotary table in such a way that given simultaneous, synchronized rotary movement of the loading star and of the rotary table, workpieces which are held in successive receptacles in the loading star can be transferred successively into corresponding receptacles in the rotary table.

In order to unload the rotary table, an unloading star which can rotate about a vertical axis is similarly often used with circumferential receptacles and is in turn arranged adjacent to the rotary table so that given simultaneous, synchronized rotary movement of the rotary table and of the unloading star, workpieces which are held in successive receptacles in the rotary table can be transferred successively into corresponding receptacles in the unloading star.

So that, when there are high production speeds, the workpieces which are to be machined can be fed with a sufficient throughput rate to the machining device, two (or even more) conveyor devices are often necessary in order to charge the loading star with workpieces. The workpieces are thus fed in two (or more) tracks. There is then the problem of how the known loading star can successively be charged with these workpieces which are fed on two or more tracks.

Similarly, after being transported away from the rotary table the workpieces must often be divided into two or more tracks, for example because successive machines or devices, for example testing machines or testing cameras, have a lower production speed than the machining device with the rotary table.

Often, in particular when manufacturing comparatively small batches, it is also desired for different workpieces (for example differently colored workpieces) to be subjected to the same machining steps in the same machining device. In this respect, feeding workpieces on two or more tracks has the advantage that different workpieces can be fed separately to the rotary table. Running empty times, such as arise during the sequential machining of different batches, for example because it is necessary to “run empty” the machining device between two batches, can be avoided. However, in this case there is the problem of how the different workpieces can be sorted again quickly and reliably after the machining, that is to say for example divided up among a plurality of tracks.

### SUMMARY OF THE INVENTION

The object of the invention is to provide devices from the technical field mentioned at the beginning which have the purpose of feeding and transporting away workpieces and which permit multi-track feeding and/or removal of workpieces, and which are of simple design and suitable for high production speeds.

The means of achieving the object are defined by the features of claims 1 and 16. According to the invention, a device for feeding workpieces has a first feed device which is designed in such a way that it can partially charge the loading star with workpieces, and a second feed device which is arranged ahead of the first feed device in the direction of rotation of the loading star and is embodied in such a way that it can charge workpieces into receptacles in the loading star which have not been charged by the first feed device.

Analogously, a device for transporting away workpieces has a first removal device which is embodied in such a way that it can transport away some of the workpieces held in the unloading star from the unloading star, and a second removal device which is arranged ahead of the first removal device in the direction of rotation of the unloading star and is embodied in such a way that it can transport away from the unloading star, workpieces which have not been transported away by the first removal device and are held in the unloading star.

The loading star is thus charged with workpieces by two or more feed devices in two or more stages; workpieces are transported away from the unloading star in two or more stages by two or more removal devices. The loading star is charged by the first feed device only partially, i.e. not all the receptacles in the loading star which pass the first feed device are charged systematically with a workpiece. The second feed device, which is passed by the receptacles in the loading star after passing through the first feed device, charges receptacles in the loading star which have remained empty after passing through the first feed device. If there is also a following third feed device, the charging process by the second feed device is also only carried out partially, i.e. empty receptacles systematically remain for charging by subsequent feed devices.

The workpieces are transported away in basically the same way: the first removal device systematically does not remove all the workpieces which are held in the unloading star and which pass the first removal device but rather firstly leaves workpieces in the unloading star. They can be subsequently removed from the second removal device (and possibly further removal devices) and transported away.

The device for feeding and the device for transporting away thus implement the same principle according to the invention. The proven arrangement which permits high production speeds and which has a loading star or unloading star which adjoins the rotary table can continue to be used. This also ensures that existing machining devices can be retrofitted. The arrangement according to the invention permits a compact design of the machining device with the associated devices for feeding and transporting away.

For feeding workpieces to the rotary table of the machining device it is possible to use the device according to the invention for feeding independently of the device used for transporting away. The machined workpieces can, for example, be discharged directly from the rotary table onto a jet stream conveyor, onto a conveyor belt or into a collecting container.

Similarly, the device according to the invention for transporting away can be used for transporting away workpieces from the rotary table of the machining device independently of the device used for feeding. Particular advantages are however obtained if both the feeding and the transporting away are carried out with the respective device according to the invention, that is to say if a machining device comprises both a device according to the invention for feeding and a device according to the invention for transporting away. This permits high production speeds both for feeding and for further transportation or further machining of the workpieces after they pass through the machining device. In addition, the devices according to the invention can ensure orderly feeding and orderly transporting away. Different workpieces which are fed on a plurality of tracks can thus be carried away again on a plurality of tracks without additional expenditure on sorting, with different types of workpiece being transported on again on different tracks.

If the device according to the invention for feeding and the device according to the invention for transporting away are combined in one machining device, the number of feed devices (and thus the “tracks” on the feed side) and the number of removal devices (and thus the “tracks” on the removal side) correspond to one another, but they can also be different. For example, the material can easily be fed, for example, on three tracks and removed on two tracks.

The devices according to the invention are suitable, in particular, for machining plastic closures, for example in cutting machines or folding and cutting machines, where a high production speed is to be ensured. However, they are also suitable for use in other machining devices with rotary tables. A machining device can also have a plurality of rotary tables through which the workpieces pass in succession (during the machining of plastic closures, for example, a rotary table for folding and a rotary table for cutting a securing ring). The rotary tables are advantageously connected to one another by means of transfer stars.

The second feed device of a device for feeding workpieces advantageously comprises an intermediate star which is embodied as a rotary star and has circumferential receptacles for the workpieces. The rotary star is embodied and arranged in such a way that given simultaneous, synchronized rotary movement of the intermediate star and of the loading star, workpieces which are held in intermediate star receptacles can be successively transferred into corresponding receptacles in the loading star.

A charging device which can charge the intermediate star partially with workpieces is preferably arranged ahead of the intermediate star. The charging device therefore systematically does not charge all the receptacles in the intermediate star which pass it. As a result it is possible for the loading star to be only partially charged with workpieces by the second feed device via the intermediate star.

The charging device is preferably a charging star which is embodied as a rotary star and has circumferential receptacles for the workpieces. The charging star is embodied and arranged in such a way that given simultaneous, synchronized rotary movement of the charging star and of the intermediate star, workpieces which are held in receptacles in the charging star can be successively transferred into corresponding receptacles in the intermediate star.

The charging of the intermediate star does not necessarily have to be carried out by means of a charging star, other types of charging devices, for example a linear duct whose axis is arranged radially with respect to the intermediate star, or gripper means, are also possible.

If the intermediate star and the loading star used permit partial charging of the loading star by the second feed device, it is possible, instead of using a charging device which permits partial charging of the loading star, firstly to feed workpieces to all the receptacles in the intermediate star which pass the charging device.

The intermediate star and the loading star are preferably embodied and arranged in such a way that given simultaneous, synchronized rotary movement of the intermediate star and of the loading star, respectively adjacent receptacles in the intermediate star and adjacent receptacles in the loading star are successively moved into a mutual interaction region. The circumferential speed of the intermediate star and of the loading star and the distance between successive receptacles are therefore matched to one another in such a way that in the interaction region (i.e. in the region of the connecting line between the centers of the two stars in which the distance between the stars is at a minimum), there is in each case also always a receptacle in the intermediate star if a receptacle is located in the loading star at that point. Such a method of functioning is implemented most simply if two elements with the same diameter and the same spacing between successive receptacles are used as the intermediate star and as the loading star, in which case both stars are rotated at the same angular speed. If rotary star elements with different diameters are used, their angular speeds must be adapted to one another in such a way that the circumferential speeds correspond to one another again and pockets in the two elements which are intended to interact with one another pass through the interaction region simultaneously.

In an analogous way to the device for feeding workpieces, the first removal device advantageously comprises a device for removing workpieces, an intermediate star which is embodied as a rotary star and has circumferential receptacles for the workpieces. The intermediate star is embodied and arranged in such a way that given simultaneous, synchronized rotary movement of the intermediate star and of the unloading star, workpieces which are held in unloading star receptacles can be transferred successively into corresponding receptacles in the intermediate star.

A pickup star with circumferential receptacles for the workpieces is advantageously arranged after the intermediate star. Said pickup star is embodied and arranged in such a way that given simultaneous, synchronized rotary movement of the intermediate star and of the pickup star, workpieces which are held in receptacles in the intermediate star can be transferred successively into corresponding receptacles in the pickup star.

Alternatively, the workpieces are discharged directly from the intermediate star to some other type of conveyor device or collecting device (for example onto a conveyor belt or into a collecting container).

The intermediate star and the unloading star are preferably embodied and arranged in such a way that given simultaneous, synchronized rotary movement of the intermediate star and of the unloading star, respectively adjacent receptacles in the intermediate star and adjacent receptacles in the unloading star are moved successively into a mutual interaction region. The circumferential speed of the intermediate star and of the unloading star and the distance between successive receptacles are therefore matched to one another in such a way that in the interaction region (i.e. in the region of the connecting line between the centers of the two stars in which the distance between the stars is at a minimum) there is also always in each case a receptacle in the intermediate star if a receptacle in the unloading star is located at that point. Such a method of functioning is implemented most simply if two elements with an identical diameter and identical spacing between successive receptacles are inserted as an intermediate star and as an unloading star, in which case the two stars are rotated at the same angular speed.

In the device for feeding workpieces, the first feed device preferably comprises a feed star which is embodied as a rotary star, has circumferential receptacles for the workpieces and is embodied and arranged in such a way that given simultaneous, synchronized rotary movement of the feed star and of the loading star, workpieces which are held in receptacles in the feed star can be successively transferred into corresponding receptacles in the loading star.

Correspondingly, a device for transporting away workpieces comprises a removal star which is embodied as a rotary star, has circumferential receptacles for the workpieces and is embodied and arranged in such a way that given simultaneous, synchronized rotary movement of the unloading star and of the removal star, workpieces which are held in receptacles in the unloading star can be transferred successively into corresponding receptacles in the removal star.

If the workpieces are fed on two tracks, a device according to the invention for feeding workpieces can have, in particular, the following configuration. In a predefined time interval T in which a number of M receptacles in the loading star interact with corresponding receptacles in the rotary table, a number of M/2 receptacles in the feed star which are charged with workpieces interact with corresponding receptacles in the loading star. In this context, every second receptacle in the loading star is charged with a workpiece. The charging device of the second feed device is embodied in such a way that every second receptacle in the receptacles in the intermediate star which interact with the loading star is charged with a workpiece. In the time interval T, a number of M receptacles in the intermediate star then also interact with receptacles in the loading star. Of these receptacles, every second one is charged with a workpiece, and in the time interval T, M/2 workpieces are thus transferred from the intermediate star to the loading star and held by those receptacles which were still empty after passing through the first charging device.

The configuration is then advantageously selected in such a way that in order to partially charge the intermediate star in the time interval T a number of M/2 receptacles in the charging star interact with corresponding receptacles in the intermediate star, in which case adjacent receptacles in the charging star interact with the respective next but one receptacles in the intermediate star.

Similarly, in order to partially charge the loading star in the time interval T, a number of M/2 receptacles in the feed star interact with corresponding receptacles in the loading star, in which case adjacent receptacles in the feed star interact with the respective next but one receptacles in the loading star.

The device for transporting away can be of analog design for two-track removal of the workpieces: in a predefined time interval T in which a number of M receptacles in the removal star interact with corresponding receptacles in the rotary table, a number of M receptacles in the intermediate star also interact with the unloading star. The device is then embodied and controlled in such a way that workpieces in every second receptacle in the unloading star are transported from the unloading star and into the intermediate star, that is to say M/2 workpieces in the time interval T. In this time interval T, a number of M/2 receptacles in the unloading star which are still charged with workpieces also interact with corresponding receptacles in the removal star, and the corresponding workpieces are transported into the removal star.

The removal star is advantageously embodied in such a way that, in the time interval T, a number of M/2 receptacles in the removal star interact with corresponding receptacles in the intermediate star and each hold one workpiece. This means that adjacent receptacles in the removal star interact with respective next but one receptacles in the intermediate star.

Similarly, in order to unload the intermediate star in the time interval T, a number of M/2 receptacles in the removal star interact with corresponding receptacles in the intermediate star, wherein adjacent receptacles in the removal star interact with the respective next but one receptacles in the intermediate star. Each of the receptacles in the removal star which passes through the interaction region with the intermediate star thus picks up a workpiece to transport it onward.

The receptacles in the various rotary star elements, i.e. the loading star or the removal star, and if appropriate also in the intermediate star, the charging star, the feed star, the pickup star and/or the removal star are advantageously embodied as pockets which are open at the circumference. A workpiece which is held in a pocket in a first rotary star element can be moved essentially radially into a pocket in an adjacent second rotary star element if the two pockets are located in their mutual interaction region (in the region of the connecting line between the rotary centers of the two rotary star elements involved). This solution is structurally simple and permits simple and rapid transfer of the workpieces from one rotary star element to the next. The transfer can be brought about by centrifugal forces, by the force of gravity if the second rotary star element is located at a lower point than the first, by mechanical means such as, for example, tappets or by compressed air. The solution with circumferential pockets is particularly suitable for rotationally symmetrical workpieces such as, for example, plastic closures or for other workpieces in which precise orientation in the receptacles is not required.

In this solution with circumferential pockets, the preferred embodiment of the intermediate stars described above acquires particular significance. The intermediate star specifically comprises pockets which, while the device is operating, are not charged with workpieces by the charging device or which are not intended to hold workpieces from the unloading star. These pockets nevertheless interact (like the charged pockets) with the pockets in the loading star or unloading star, in which case respective adjacent pockets in the intermediate star interact with adjacent pockets in the loading or unloading star. The pockets in the intermediate star which are not charged clear the path in the interaction region for the workpieces which have already been held in the loading star or unloading star, fed by the first feed device or removed by the unloading star so that said workpieces can pass through the interaction region without being influenced by the intermediate star. The workpieces are therefore held in the interaction region partially both by the pockets in the loading star or unloading star and by the pockets in the intermediate star. Suitable guide elements (for example external guides or movable fingers, see below) ensure that the workpieces which have already been held in the loading star or unloading star also continue to be held in it and transported on with it.

This structural design and arrangement of the intermediate stars permits pockets to be used which are embodied in such a way that in the held state the workpieces project outward beyond a circumference of the rotary star element. The pockets are therefore comparatively flat and their depth is less than the corresponding extent of the workpieces. As a result, the radial path which is to be covered when a rotary star element is transferred to the next workpiece is reduced, and permits a higher production speed.

Furthermore, the workpieces which project partially beyond the pockets can be grasped more easily and transferred more simply from one element to the next.

So that the workpieces remain secured in the circumferential pockets during the rotary movement of the rotary star elements, external guides can be arranged radially spaced apart at the circumference from at least one of the rotary star elements. Said guides prevent the workpieces being able to be moved radially outward from the pockets during the rotary movement owing to the centrifugal forces. The external guides can be interrupted in the interaction regions in order to permit transfer to a subsequent rotary star element.

The rotary star elements are advantageously orientated essentially horizontally. External guides can be arranged both on an underside and on an upper side of the rotary star elements. If both the underside and the upper side are used, increased flexibility of the configuration of the external guides, in particular in interaction regions between adjacent rotary star elements, occurs. The external guide of the first rotary star element can thus be arranged on the upper side, while the external guide of the subsequent second rotary star element lies on the underside. In this way the greatest possible degree of freedom is obtained with the configuration of the external guides. In order to convey workpieces of a certain height, for example rotary star elements are used with a thickness which corresponds approximately to a third of the height of the workpiece. The external guides which are arranged on the underside and on the upper side of the rotary star elements likewise each have a thickness of approximately one third of the height of the workpiece. The workpieces can thus be reliably guided both by the rotary star elements and by the external guides arranged below and above.

In one device for feeding workpieces to a rotary table, the intermediate star (and if appropriate its charging device) are preferably arranged on a plane which is higher than the loading star. As a result of this arrangement on a plurality of levels, the freedom of configuration of the guides is increased further. The workpieces which are already located in the loading star can in this way continue to be secured during the charging of the still empty receptacles in the loading star from the intermediate star by a guide in the loading star which runs underneath the intermediate star.

The rotary star elements of the devices for feeding and/or removing the workpieces can have movable fingers in order to secure the workpieces in the pockets. These can be used in combination with external guides or as replacement for them. The movement of the fingers is controllable so that at the desired rotary position the workpieces can be removed from the receptacles, in particular from the pockets. In a device for feeding workpieces, in particular the intermediate star and the loading star have movable fingers. This permits the workpieces fed to the intermediate star to be selectively transferred to the loading star and the workpieces located in the loading star to be already secured ahead of the interaction regions during the passage through the interaction region. The geometry of the interaction region and the necessary external guides, interacting with the rotary star elements, for the workpieces can thus be simplified. In particular, in the feed device the intermediate star and the loading star can readily be arranged in the same horizontal plane.

In a device for removing workpieces, in particular the unloading star and the intermediate star have movable fingers. This permits selective transfer of every second workpiece secured in the unloading star to the intermediate star, while the further workpieces are firstly secured in the unloading star and not released into the interaction region with the removal star. The fingers of the intermediate star permit the workpieces which are released by the unloading star to be securely gripped and secured.

Instead of fingers, the intermediate star of the feed device and the unloading star and the intermediate star of the removal device can also have radially movable tappets. With its assistance, the workpieces in the interaction region between the intermediate star and the loading star or between the unloading star and the intermediate star are moved in a controlled fashion into the pockets of the respective other rotary star element or secured therein. All the pockets of the intermediate star are equipped with tappets. In the interaction region, the tappets are moved in such a way that workpieces located in the pockets in the intermediate star are moved into the opposite pockets in the loading star and subsequently secured therein as far as the outlet of the interaction region. The tappets of the pockets, not charged with workpieces, in the intermediate wheel are moved radially outward in the outlet of the interaction region so that workpieces which have been led into the loading star are not incorrectly passed on in the intermediate star.

In the removal device, those pockets in the unloading star which hold workpieces which are to be transferred to the intermediate star and those pockets in the intermediate star which are not intended to hold any workpieces are equipped with tappets. In the interaction region, a pocket with a tappet thus always interacts with a pocket without a tappet. The tappets in the unloading star are generally pulled back radially inward so that the workpieces can be held in the pockets. At the inlet of the interaction region, the tappets of the intermediate star are also pulled back radially inward in order to permit the workpieces which are conveyed in the unloading star to pass through. At the outlet end of the interaction region, the tappets are moved radially outward so that the workpiece which is held or is not to be held in the corresponding pocket is moved into the pocket in the rotary star element opposite. The tappets can be arranged on the upper side of the rotary star elements or also under its underside.

The rotary star elements with tappets preferably interact with external guides, the guides being embodied and the tappets being controlled in such a way that the workpieces are secured securely and with little play between the respective tappet and the external guide. That is to say the tappets describe a path which is parallel to the respective external guide.

Like the fingers, the tappets also permit a simpler geometry of the interaction region and allow the external guides which interact with the rotary star elements to be simplified. In the feed device, the intermediate star and the loading star can readily be arranged in the same horizontal plane. Compared to the solution with movable fingers, there is a lower risk of damage to the workpieces, in particular closures to be machined are subject to less stress in the region of the closure opening. In addition, the same slide is always used for workpieces of the same horizontal cross section so that fewer exchange parts are necessary and adjustment works can be dispensed with. However, compared to the solution with fingers, the external guides can be configured in such a way that the workpieces remain secured, where necessary, by said fingers on the corresponding rotary star element, the slides not being capable of carrying out a securing function.

The movement of the fingers or of the tappets is advantageously controlled by a cam controller. The latter comprises in particular fixed cams which are assigned to the rotary star elements which are provided with fingers and/or tappets and by means of which the fingers and/or tappets are activated mechanically during the rotary movement of the rotary star elements. In the case of an intermediate star, equipped with tappets, of the feed device it is possible to use two fixedly arranged cams located one on top of the other, the tappets being alternately controlled by one cam or the other for those pockets which are intended to hold workpieces and for those pockets which remain empty.

The rotary movement of the rotary table and of the loading star or unloading star as well as further rotary star elements is preferably synchronized by gearwheels which interact with one another and are connected in a rotationally fixed fashion to axles of the rotary star elements. This easily provides reliable synchronization with little play, which is also suitable for high production speeds.

Further advantageous embodiments and feature combinations of the invention result from the following detailed description and the entirety of the patent claims.

### BRIEF DESCRIPTION OF THE DRAWINGS

In the drawings used to explain the exemplary embodiment:

FIG. 1 is an oblique view of a device according to the invention for feeding plastic closures to a rotary table of a machining device;

FIG. 2 is a plan view of the upper side of the device;

FIG. 3 is a plan view of the underside of the device;

FIG. 4 is a detailed view of the transfer region from the intermediate star to the loading star,

FIG. 5 is a plan view of the inlet adjoining the transfer region from the intermediate star to the loading star;

FIGS. 6A-D show various configurations of devices according to the invention for feeding workpieces;

FIG. 7 is an oblique view of an arrangement with a device according to the invention for feeding plastic closures to a rotary table and a device according to the invention for transporting away the plastic closures;

FIG. 8 shows a cross section through the unloading star and the intermediate star of the device according to the invention for transporting away;

FIG. 9 shows a plan view of the upper side of the arrangement;

FIG. 10 shows a plan view of the underside of the arrangement; and

FIG. 11 shows a schematic oblique view of an alternative embodiment of the unloading star and of the intermediate star of the device for transporting away.

Basically, identical parts in the figures are provided with identical reference symbols.

Ways of implementing the invention

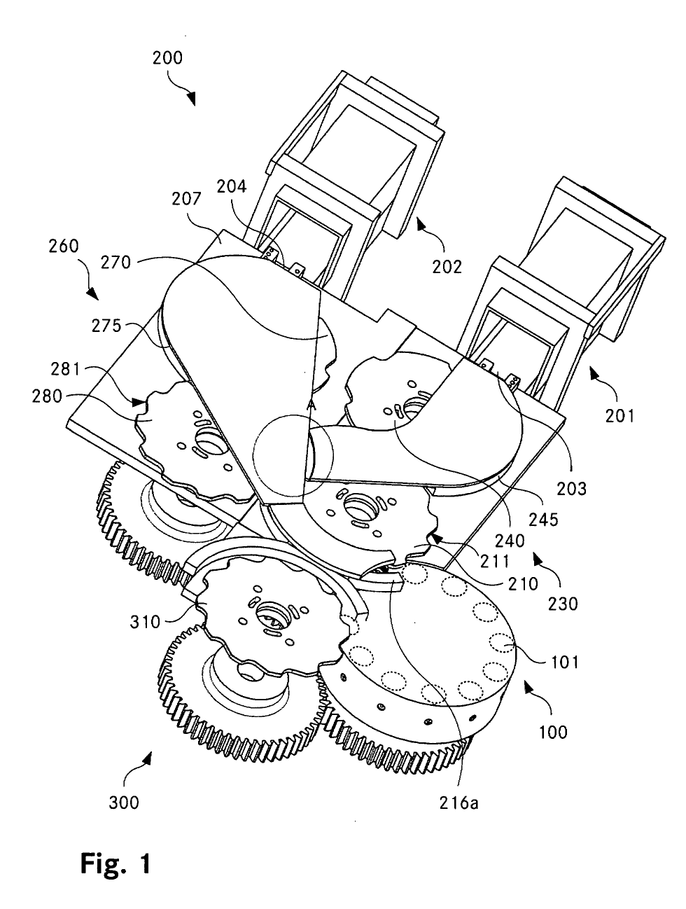

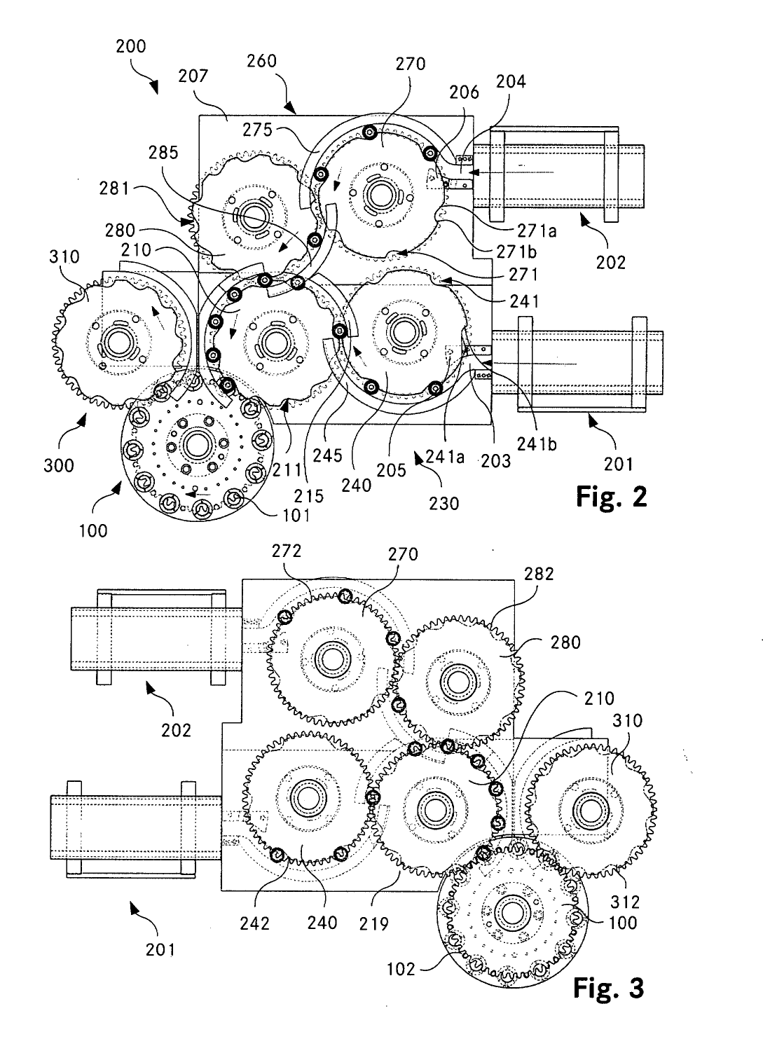

FIG. 1 shows an oblique view of a device according to the invention for feeding plastic closures to a rotary table of a machining device, FIG. 2 shows a plan view of the upper side, FIG. 3 shows a plan view of the underside of the device. With a device according to the invention it is possible to feed plastic closures with diameters of approximately 25-50 mm and with heights of approximately 10-25 mm, it being possible to exchange certain parts of the device in a manner known per se in order to retrofit to different diameters and, if appropriate, different heights. Only the rotary table 100 of the machining device is illustrated. The latter comprises on the circumference twelve pickup places 101 which can each pick up a closure. The design of the pickup places 101 depends on the respective machining device and is not presented in more detail here. The closures are guided, together with the rotary movement of the rotary table 100, through one or more machining tools of the machining device.

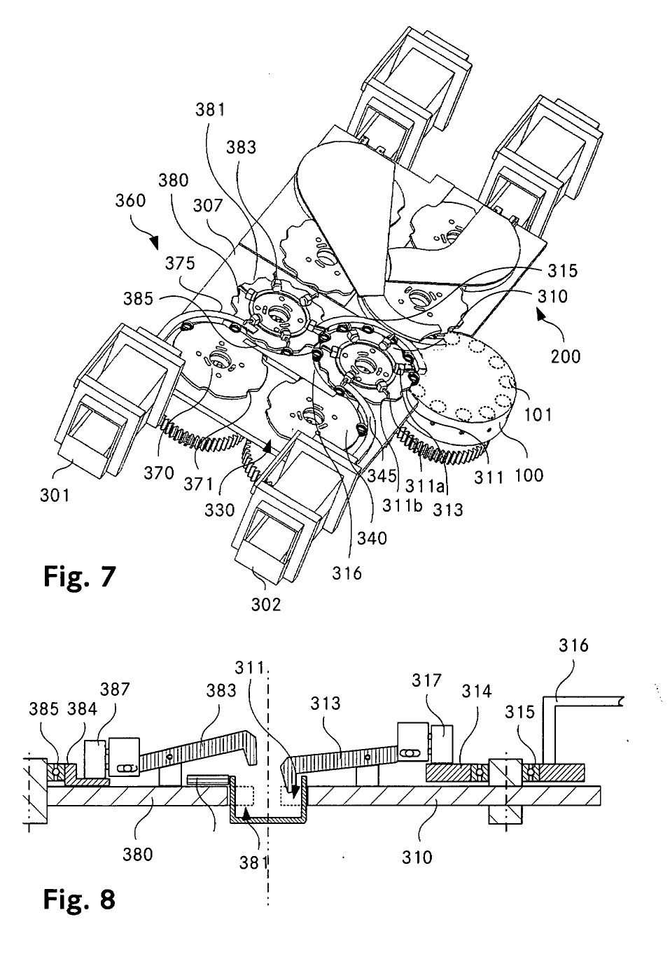

The closures are fed to the rotary table 100 by a feed device 200, and after machining has taken place the closures are removed from the rotary table 100 by a removal device 300 and transported onward. In FIGS. 1-3, in each case just one unloading star 310 of the removal device 300 is illustrated, and a removal device 300 which can be used together with the rotary table of a machining device is described further below in detail in conjunction with FIGS. 7-10.

The plastic closures are conveyed on two tracks by means of jet stream conveyors 201, 202 which are known per se, and are introduced into a duct 203, 204 respectively one behind the other on each track. The ducts 203, 204 each lead to one rotary star element of a feed device, specifically to a feed star 240 of a first feed device 230 or to a charging star 270 of a second feed unit 260. The closure which is fed in at the respective frontmost position strikes against the circumference of the feed star 240 or of the charging star 270. The feed star 240 and the charging star 270 are embodied as plate-like elements which rotate about a vertical axis which is mounted in a base frame 207. The main faces of the plates are oriented horizontally. The plates are essentially circular, but each have six pockets 241, 271 at the circumference (see FIG. 2). These are embodied as continuous, essentially V-shaped recesses, with the front limb 241a, 271a in the direction of rotation of the respective rotary star element enclosing, at its circumferential-side outlet point, an obtuse angle with the tangent there of the plate-like element. The rear limb 241b, 271b in the direction of rotation adjoins at its end, which again merges with the circular circumference, a somewhat more acute angle with the tangent there; in the example illustrated the angles are approximately 35° at the front limb 241a, 271a and approximately 65° at the rear limb 241b, 271b. The front limit 241a, 271a thus forms a run-in slope, and the rear limb 241b, 271b forms a stop for the closure.

If the rotary star elements are made to rotate about their vertical axis, the closures which are fed in the ducts 203, 204 are carried along by the pockets 241, 271 as soon as they pass through the mouth of the respective duct 203, 204: the frontmost closure is pressed forward by the jet stream conveyor 201, 202 and by means of the closures lying behind it and thus passes—supported by the run-in slope of the front limb 241a, 271a—into the pocket 241, 271. As soon as it has reached the base of the pocket, it is carried along through the feed star 240 or the charging star 270, with the closure bearing against the rear limb 241b, 271b. The depth of the pockets 241, 271 is selected such that only approximately ⅖ of the diameter of the closure is secured in the pocket 241, 271, and the rest of the closure projects beyond the circumference of the plate-shaped element.

The feeding of the closure into the respective pocket 241, 271 is supported by a deflection element 205, 206 which forms the rear wall of the duct 203, 204 in the direction of rotation of the rotary star element and which is bent forward slightly in the direction of rotation at the mouth of the duct. The front end of the deflection element 205, 206 is guided under the plate-like element of the feed star 240 or of the charging star 270 so that the closure can be transferred seamlessly from the duct 203, 204 into the pocket 241, 271. Since the two rotary star elements each have six pockets 241, 271 which are arranged uniformly along the circumference, a further closure is held by them after a respective rotation of 60°.

So that the closures which are held in the pockets 241, 271 remain secured in the pockets 241, 271 during the rotary movement of the feed star 240 or of the charging star 270, guides 245, 275 which are arcuate at the circumferential side are permanently arranged on the base frame 207 spaced radially apart from the respective rotary star element. The radial distance of the guides 245, 275 is matched to the diameter of the closures and the depth of the pockets 241, 271 in such a way that during the rotary movement of the rotary star elements the closures remain secured in the pockets 241, 271 only with little play, and thus precisely follow the movement of the circumference of the rotary star elements.

In the configuration illustrated in FIGS. 1-3, the feed star 240 and the charging star 270 run in opposite directions, viewed from above the feed star 240 rotates in the clockwise direction, while the charging star 270 rotates in the anticlockwise direction. Correspondingly, the guides 245, 275 adjoin the mouths of the ducts 203, 204 in the clockwise direction or in the anticlockwise direction. The guide 245 of the feed star 240 describes approximately an arc of 145°, and therefore ensures that the closures are transported over approximately 145° with the feed star 240. The guide 275 of the charging star 270 describes approximately an arc of 170°, and the closures held by the charging star 270 are therefore carried along by it over this angle.

The second feed device 260 also comprises an intermediate star 280 which can also be rotated about a vertical axis mounted in the base frame 207. The intermediate star 280 is basically designed like the charging star 270, but has twelve pockets 281 instead of six and rotates in the opposite direction to the charging star 270. The intermediate star 280 and the charging star 270 are arranged with respect to one another in such a way that closures held in an interaction region in the charging star 270 can be transferred to the intermediate star 280. For this purpose, the two rotary star elements are spaced apart from one another in such a way that in a rotary position of the rotary star elements in which two pockets 271, 281 are located opposite one another in the interaction region, a closure can be held temporarily by both pockets 271, 281. The distance between the circle-segment-like edges of the two rotary star elements is thus somewhat more than 1/5 of the diameter of a closure in the embodiment illustrated here.

The transfer of the closures from the charging star 270 to the intermediate star 280 is brought about by a guide 285 of the intermediate star 280. The guide 285 is basically designed like the guide 275 of the charging star described above, and it describes an arc of approximately 90°. In the interaction region between the charging star 270 and the intermediate star 280, said guide 285 is guided via the charging star 270, thus preventing the closure being also moved further with the charging star 270 adjacent to the interaction region. Instead, said closure is guided between the pocket 281 and the guide 285 of the intermediate star.

The diameter of the intermediate star 280 is identical to the diameter of the charging star 270, and in addition the two rotary star elements are moved at the same angular speed. Because of the different number of pockets, only every second pocket 281 in the intermediate star 280 is thus charged with a closure by the charging star 270.

The feed star 240 of the first feed device 230 interacts with a loading star 210. The latter can be rotated, like the other rotary star elements, about a vertical axis which is mounted in the base frame 207. The loading star 210 is designed like the intermediate star 280 with twelve circumferential pockets 211. It rotates in the opposite direction to the feed star 240 and thus also to the intermediate star 280. The loading star 210 and the feed star 240 are arranged with respect to one another in such a way that closures which are held in an interaction region in the feed star 240 can be transferred to the loading star 280. For this purpose, the two rotary star elements are spaced apart, similar to the intermediate star 280 and the charging star 270, in such a way that in a rotary position of the rotary star elements in which two pockets 211, 241 are located opposite one another in the interaction region, a closure can be held temporarily by the two pockets 211, 241. The distance between the circle-segment-like edges of the two rotary star elements is thus again somewhat more than 1/5 of the diameter of a closure in the embodiment illustrated here.

The transfer of the closures from the feed star 240 to the loading star 210 is brought about by a guide 215 of the loading star 210. The guide 215 is basically embodied like the guides described further above, it describes an arc of approximately 45°. In the interaction region between the feed star 240 and the loading star 210, it is guided via the feed star 240, thus preventing the closure also being moved on with the feed star 240 adjacent to the interaction region. Instead, said closure is guided between the pocket 211 and the guide 215 of the loading star. The diameter of the loading star 210 is equal to the diameter of the feed star 240, and the two rotary star elements are additionally moved with the same angular speed. Because of the different number of pockets, only every second pocket 211 of the loading star 210 is thus charged with a closure by the feed star 240.

The loading star 210 is arranged with respect to the intermediate star 280 of the second feed device 260 in such a way that an interaction region in which closures can be transferred from the intermediate star 280 to the loading star 210 is also formed between these rotary star elements. The geometry corresponds to that in the interaction regions between the charging star 270 and the intermediate star 280 or the feed star 240 and the loading star 210. The interaction region of the intermediate star 280 and of the loading star 210 lies ahead of the interaction region with the feed star 240 in the direction of rotation of the loading star 210, i.e. every second pocket 211 which is guided by the rotary movement of the loading star 210 into this interaction region has already been charged with a closure by the first feed device 230.

These closures which are held in the loading star 210 are intended to pass through the interaction region with the intermediate star 280 without being influenced and be transported on with the loading star 210. At the same time, closures are placed in the remaining, still uncharged pockets 211 by the intermediate star 280 of the second feed device 270. For this purpose, the entire second feed device 270 is arranged at a higher level, by approximately 4 mm, than the first feed device 230, and the loading star 210, i.e. the closures, slide in this feed device 270 on a higher plane by approximately 4 mm. During the transfer from the intermediate star 280 into the pockets 211 of the loading star 210 the closures drop onto the lower level of the loading star 210.

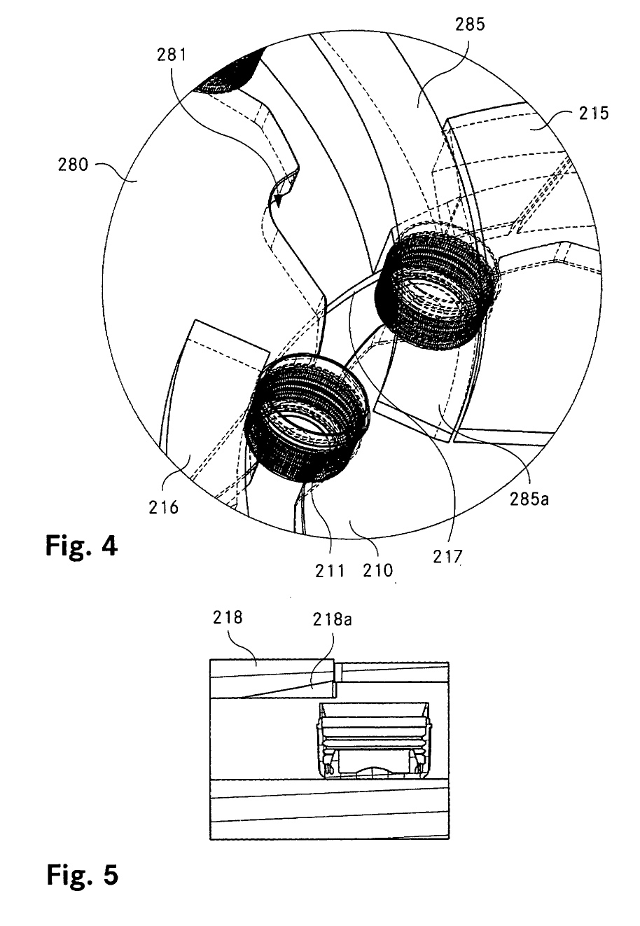

FIG. 4 shows a detailed view of the transfer region from the intermediate star 280 to the loading star 210. At the transfer from the higher level of the second feed device 270 to the plane on which the closures which are held in the loading star 210 are guided, a shoulder 217 is formed. The latter forms the arcuate continuation of the guide 215 and guides the closures which are already discharged into the loading star 210 from the first feed device 230, during the passage through the interaction region with the intermediate star 280. These closures can run through the interaction region without impedance because as they pass through an empty pocket 281 of the intermediate star 280 simultaneously passes through the interaction region and thus clears the way for the closure which has already been held in the loading star 210.

The closures held in pockets 281 in the intermediate star 280 are firstly fed along the guide 285 assigned to the intermediate star, then drop via the shoulder 217 and arrive in the still uncharged pockets 211 in the charging star 210. This movement is firstly guided by the guide 285, and the latter therefore comprises a section 285a which is guided over the path of the closures which are already located in the loading star 210. As soon as the closure is held in the pocket 211, it is secured, like the closures which are already previously located in the loading star 210, in the loading star 210 by the guide 216. This guide 216 is in turn basically designed like the guides described further above and describes an arc of approximately 135°.

In order to smooth the closures of the second feed device which drop onto the lower level, a height guide 218 with a run-in slope 218a is arranged in the interaction region (see FIG. 5). The movement of the various rotary star elements is synchronized in such a way that in each case pockets of the two rotary star elements are located directly opposite in the interaction regions. This synchronization is carried out by means of gearwheels which are connected in a coaxially and a rotationally fixed fashion to the respective rotary star elements, with the gearwheel 219 which is coupled to the loading star 210 intermeshing with the gearwheel 102 of the rotary table 100, and the gearwheel 282 of the intermediate star 280 and the gearwheel 242 of the feed star 240 likewise intermeshing with the gearwheel of the loading star 210. The gearwheel 272 of the charging star 270 finally intermeshes with the gearwheel 282 of the intermediate star 280. The unloading star 310 is also coupled to the rotary table 100 via a gearwheel 312.

The feed devices 230, 260 are set in such a way that after passing through the interaction region with the intermediate star 280 all the corresponding pockets 211 of the loading star 210 are charged with a closure. The closures are then guided together with the loading star 210 through the guide 216 as far as over the rotary table 100 and can then be picked up by the receptacles 101 in the rotary table. The plane of the rotary table 100 corresponds here to the guide plane for the closures in the region of the loading star 210. The section 216a, projecting beyond the rotary table 100, of the guide 216 has on its underside a recess through which securing elements of the rotary table 100 can pass.

After the machining in the machining station during the rotating movement of the rotary table, the closures are removed again from the pickup places 101 by an unloading star 310 of the removal device 300, and transported onward, for example to a subsequent machining station, a collecting container or another conveyor device.

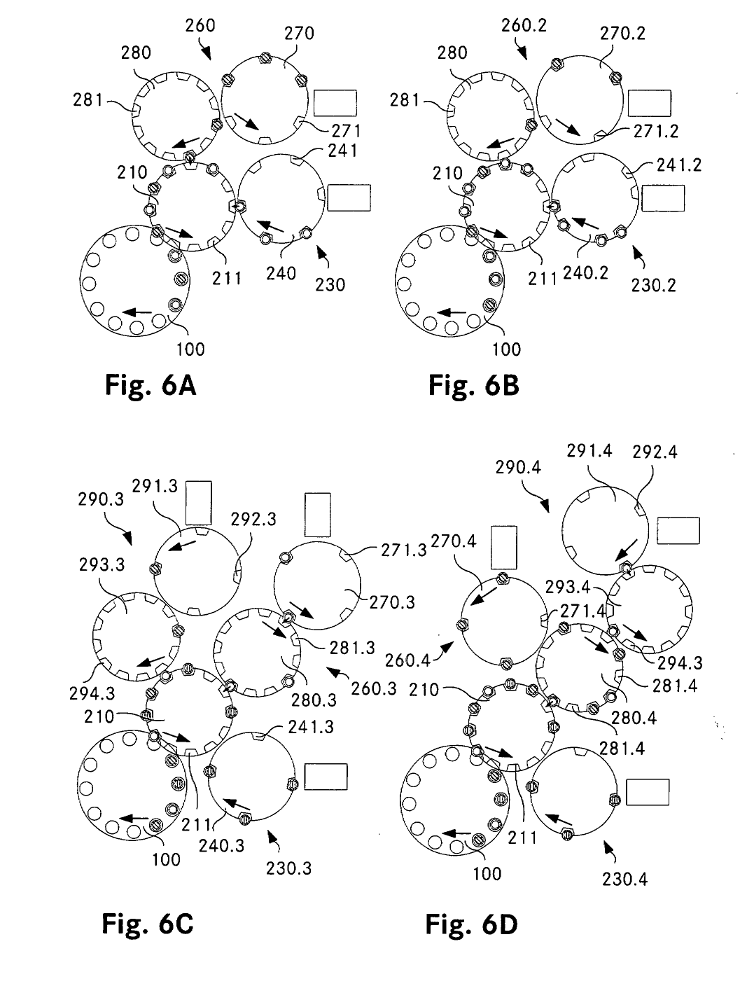

The device illustrated in conjunction with FIGS. 1-5 can be carried out with various configurations. FIGS. 6A-D show, as examples, various configurations in a schematic form. For the sake of clarity, elements such as guides, drive elements etc. are omitted. FIG. 6A represents the configuration which has already been described above: the closures are fed on two tracks by means of two feed devices 230, 260. The first feed device 230 comprises a feed star 240 which can transfer closures directly to the loading star 210. The second feed device comprises a charging star 270 from which the closures pass into the loading star 210 via an intermediate star 280. All the rotary star elements have the same diameter and are moved at the same angular speed.

The feed star 240 of the first feed device 230 is located behind the intermediate star 280 of the second feed device 260 in the direction of rotation of the loading star 210. The closures from the feed star thus pass into the loading star 210 before the corresponding section of the loading star 210 interacts with the intermediate star 280. The feed star 240 and the charging star 270 each comprise six pockets 241, 271 and thus charge every second of the twelve pockets 211, 281 in the loading star 210 or in the intermediate star 280. The intermediate star 280 is synchronized with the loading star 210 in such a way that the closures which are held can be discharged into the pockets which have remained empty after the passage through the interaction region with the feed star 240. In each case a closure from the first track (first feed device 230) and from the second track (second feed device 260) is alternately fed to the rotary table 100.

FIG. 6B shows a variation of the configuration in FIG. 6A which differs from the configuration described above only in that the feed star 240.2 has eight instead of six pockets 241.2 which occupy the positions 1, 2, 4, 5, 7, 8, 10, 11 of a uniform division into twelve. The charging star 270.2 has only four pockets 271.2, instead of six, said pockets being distributed uniformly along the circumference. The feed star 240.2 will thus respectively charge two subsequent pockets 211 in the loading star 210 with a closure and subsequently leave one pocket 211 empty. Every third pocket 281 is charged by the intermediate star 280. The intermediate star 280 is synchronized with the loading star 210 in such a way that the closures which are held can be discharged into the pockets which have remained empty after the passage through the interaction region with the feed star 240.2. Two closures from the first feed device 230.2 and a closure from the second feed device 260.2 are thus fed alternately to the rotary table 100.

FIGS. 6C and 6D show examples of three-track feeds. The device illustrated in FIG. 6C comprises a first feed device 230.3 with a feed star 240.3 with four pockets 241.3 which are distributed uniformly along the circumference. The closures held therein can be discharged directly into the loading star 210. The second feed device 260.3 comprises a charging star 270.3 with four pockets 271.3 which are distributed uniformly along the circumference. Said charging star 270.3 interacts with an intermediate star 280.3 with twelve pockets 281.3 from which held closures can be discharged into the loading star 210. The intermediate star 280.3 is arranged ahead of the feed star 240.3 of the first feed device 230.3 in the direction of rotation of the loading star 210.

The device also comprises a third feed device 290.3 with a charging star 291.3 with four pockets 292.3 as well as an intermediate star 293.3 arranged afterwards with twelve pockets 294.3. Closures held in the latter can be discharged to the loading star 210, the interaction region between the intermediate star 293.3 of the third feed device 290.3 being located in turn ahead, in the direction of rotation, of the interaction region with the intermediate star 280.3 of the second feed device 260.3. The loading star 210 is thus successively charged with closures from the first, second and third feed devices 230.3, 260.3, 290.3, and correspondingly the rotary table 100 respectively receives closures cyclically in succession from the first, second and third tracks.

FIG. 6D shows an alternative way of implementing a three-track feed. The first feed device 230.4 is identical to that shown in FIG. 6C, it interacts directly with the loading star 210 with twelve pockets 211. For the second and third feed devices 260.4, 290.4 a common intermediate star 280.4 which also has twelve pockets 281.4 is provided, said intermediate star 280.4 holding closures from the two feed devices 260.4, 290.4 and interacting with the loading star 210. The second feed device comprises a charging star 270.4 with four pockets 271.4 which can pass on held closures to the intermediate star 280.4. The third feed device 290.4 comprises a charging star 291.4 with four pockets 292.4 and interacts by means of its own intermediate star 293.4 with twelve pockets 294.4 with the common intermediate star 280.4. The resulting charging of the rotary table 100 corresponds to that in the embodiment according to FIG. 6C.

A large number of further configurations with more than three tracks and with other feed conditions of the individual tracks are also conceivable. Different types of workpieces or identical workpieces can be conveyed onto the individual tracks. If, as in the illustrated examples, the closures project radially beyond the circumference of the rotary star elements, it is to be noted that in the interaction regions between adjacent rotary star elements the passage is cleared for closures which are already held in the received rotary star, in particular by means of empty pockets in the discharged rotary star element.

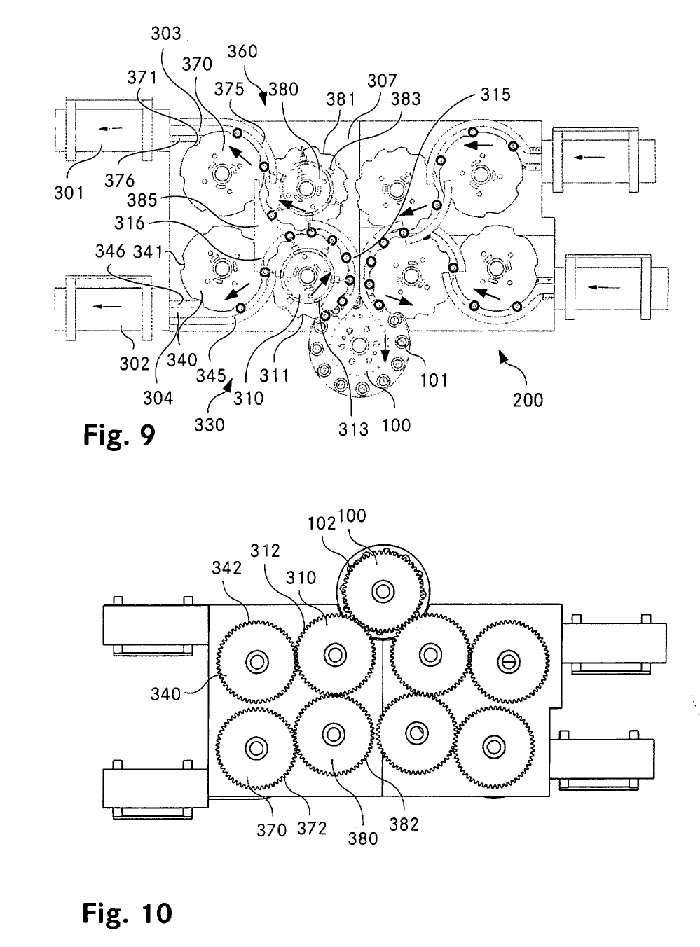

FIG. 7 shows an oblique view of an arrangement with a device according to the invention for feeding plastic closures to a rotary table and a device according to the invention for transporting away the plastic closures, a plan view of the upper side and a plan view of the underside of the arrangement being illustrated in FIGS. 9 and 10. The device 200 for feeding the closures corresponds to the device which is described in detail in conjunction with FIGS. 1-5 and has two-track feeding. Further details are not given on this in the text which follows. The rotary table 100 of a machining device with receptacles 101 for picking up closures is also again illustrated.

The device 300 for transporting away the closures comprises an unloading star 310 which is also embodied as a plate-like element which can rotate about a vertical axis mounted in a base frame 307. The main surface of the plate is oriented horizontally. The plate is essentially circular but has twelve pockets 311 arranged uniformly around the circumference.

The pockets 311 in the unloading star 310 and in the further rotary star elements of the transporting-away device 300 which are described in the text which follows are embodied (like the pockets of the feed device 200) as continuous, essentially V-shaped recesses, the front limb 311a in the direction of rotation of the respective rotary star element including at its circumferential-side outlet point an obtuse angle with the tangent there of the plate-like element. The limb 311b which is the rear one in the direction of rotation includes, at its end which merges again with the circular circumference, a somewhat more acute angle with the tangent there; in the illustrated example the angles are approximately 35° at the front limb 311a and approximately 650 at the rear limb 311b. The front limb 311a thus forms a run-in slope, and the rear limb 311b forms a stop for the closure. The depth of the pockets 311 is selected in such a way that only approximately ⅖ of the diameter of the closure is secured in the pocket 311 and the remaining part of the closure projects beyond the circumference of the plate-shaped element.

Every second pocket 311 of the unloading star 310 is provided with a moving finger 313 by means of which the closure which is held in the pockets 311 can be secured in the pockets 311 independently of an external guide during the rotary movement of the unloading star 310. The fingers 313 and their method of functioning are described in more detail below in conjunction with FIG. 8.

The pockets 311 can hold closures from the rotary table 100. For this purpose, the unloading star 310 is guided partially via the rotary table 100. The closures which are held in the rotary table 100 are picked up one after the other by successive pockets 311 in the unloading star 310 as they pass through the transfer region. So that the closures which are picked up in the pockets 311 during the rotary movement of the unloading star 310 remain secured in the pockets 311, an arcuate guide 315 on the circumference is permanently arranged at a radial distance from the unloading star 310 on the base frame 307. The radial distance from the guide 315 is matched to the diameter of the closures and the depth of the pockets 311 in such a way that during the rotary movement of the rotary star elements the closures remain secured in the pockets 311 with only little play and thus follow the movement of the circumference of the unloading star 310 precisely. The section 315a, projecting beyond the rotary table 100, of the guide 315 has, on its underside, a recess through which securing elements of the rotary table 100 can pass.

In the configuration illustrated in FIGS. 7, 9 and 10, the unloading star 310 rotates in the anticlockwise direction viewed from above. Correspondingly, the guide 315 adjoins the transfer point with the rotary table 100 in the anticlockwise direction. The guide 315 of the unloading star 310 describes approximately an arc of 150°, that is to say it ensures that the closures are transported over approximately 150° with the unloading star 310.

The unloading star 310 is adjoined by two removal devices 330, 360 which pick up closures from the unloading star 310 and transport them onward. The first removal device 360 comprises an intermediate star 380 and a pickup star 370 which is arranged after the intermediate star 380, both rotary star elements being rotatable about a vertical axis which is mounted in the base frame 307. The intermediate star 380 is basically embodied like the unloading star 310 and also comprises twelve pockets 301 and six movable fingers 383, the finger 383 interacting with every second pocket 381. The pickup star 370 has only six pockets 371 (otherwise formed in the same way), and no fingers are present. The intermediate star 380 rotates in the opposite direction to that of the unloading star 310, and the pickup star 370 in turn rotates in the opposite direction to that of the intermediate star 380. The diameters of the unloading star 310, of the pickup star 370 and of the intermediate star 380 are the same. The three rotary star elements are additionally moved at the same angular speed.

The unloading star 310 and the intermediate star 380 or the intermediate star 380 and the pickup star 370 are each arranged with respect to one another in such a way that closures which are picked up in an interaction region in the first rotary star element can be transferred to the second rotary star element. For this purpose, the two rotary star elements are spaced apart in such a way that in a rotary position of the rotary star elements in which two pockets 311, 381 and 381, 371, respectively, lie opposite one another in the interaction region, a closure can be temporarily picked up by both pockets 311, 381 or 381, 371, respectively. The distance between the circular-segment-like edges of the two rotary star elements is thus somewhat more than ⅕ of the diameter of a closure in the embodiment illustrated here.

The transfer of the closures from the unloading star 310 to the intermediate star 380 is carried out by the fingers 383 of the intermediate star 380. Closures which are picked up in pockets 311 in the unloading star 310 which are not equipped with fingers 313 are grasped by a finger 383 of the intermediate star 380 as they pass through the interaction region, and are secured in the corresponding pocket 381 in the intermediate star 380 and thus transported onward with it. The pockets 311 in the unloading star 310 which are provided with fingers 313 are secured in the pockets 311 by the fingers 313 as they pass through the interaction region. In the interaction region, every second closure is thus transferred from the unloading star 310 to the intermediate star 380, while the further closures firstly remain in the unloading star 310. The further transportation of the closures which have been picked up by the intermediate star 380 and have remained in the unloading star 310 is assisted by guides 385, 316, the guides being basically embodied like the guide 315, described above, of the unloading star 310. The guide 385 of the intermediate star 380 describes an arc of approximately 80°, and the guide 316 of the unloading star 310 describes an arc of approximately 65°.

The further interaction region with the pickup star 370 lies at the end of the guide 385 of the intermediate star 380. The pickup star 370 is synchronized with the intermediate star in such a way that closures which are conveyed in subsequent pockets 371 in the intermediate star 380 can be picked up. This is brought about by a guide 375 which is guided in the interaction region between the intermediate star 380 and the pickup star 370 via the intermediate star 380, thus preventing the closure also being moved on with the intermediate star 380 adjoining the interaction region.

The guide 375 describes an arc of approximately 90° and then carries on linearly. A duct 303 through which the closures which are conveyed in the pickup star 370 are transferred to a jet stream conveyor 301 is formed in the linear region between the guide 375 and a guide 376 lying opposite. The jet stream conveyor 301 feeds the closures to a subsequent station, for example a machining or packaging device.

The second removal device 330 is formed by a removal star 340 which can in turn be rotated about a vertical axis which is mounted in the base frame 307. The removal star is of the same design as the pickup star 370 described above and rotates at the same angular speed as the unloading star 310 but in the opposite direction.

The interaction region with the removal star 340 is located at the end of the guide 316 of the unloading star 310. The removal star 340 is synchronized with the unloading star 310 in such a way that the closures which have remained in pockets 311 in the unloading star 310 can be picked up in subsequent pockets 341 in the removal star 340. This picking up process is brought about by a guide 345 which is guided via the unloading star 310 in the interaction region between the unloading star 310 and the removal star 340, thus preventing the closure being subsequently also moved along with the unloading star 310 to the interaction region. The guide 345 describes an arc of approximately 90° and then carries on linearly. In the linear region, a duct 304 through which the closures which are conveyed in the removal star 340 are transferred to a jet stream conveyor 302 is formed between the guide 345 and a guide 346 lying opposite. The jet stream conveyor 302 feeds the closures to a subsequent station, for example a machining device or packaging device.

The movement of the various rotary star elements is synchronized in such a way that in each case pockets of the two rotary star elements lie directly opposite one another in the interaction regions. This synchronization is carried out by means of gearwheels which are connected coaxially and in a rotationally fixed fashion to the respective rotary star elements, the gearwheel 312 which is coupled to the unloading star 310 meshing with the gearwheel 102 of the rotary table 100, and the gearwheel 382 of the intermediate star 380 and the gearwheel 342 of the removal star 340 likewise meshing with the gearwheel 312 of the loading star 310. The gearwheel 372 of the pickup star 370 finally meshes with the gearwheel 382 of the intermediate star 380.

FIG. 8 shows a cross section through the unloading star 310 and the intermediate star 380 for the transporting away device 300 according to the invention. Cam plates 314, 384 are arranged by means of rotary bearings 315, 385 on the axles of the two rotary star elements. Anti-rotation elements 316 ensure that the cam plates 314, 384 are secured in a rotationally fixed fashion. The fingers 313, 383 of the rotary star elements are lifted or lowered as a function of the rotary position by means of the cam plates 314, 384 by means of rollers 317, 387 which run thereon during the rotary movement of the respective rotary star element, and said fingers 313, 383 can thus be secured in the pockets 311, 381 or released from them. It is to be noted that in FIG. 8 the unloading star 310 and the intermediate star 380 are not illustrated in synchronous rotary positions. As is apparent from FIG. 9, two pockets 311, 381 which are equipped with fingers 313 and 383 never lie opposite one another in the interaction region but instead pockets 311, 383 which are equipped with fingers 313 and 383, respectively, and pockets 311, 383 which are without fingers 313 and 383, respectively, alternate with one another.

Each finger 313 of the unloading star 310 is lowered as soon as a closure has been picked up into the corresponding pocket 311 from the rotary table 100 and lifted as soon as the interaction region with the intermediate star 380 has been passed through and the closure is guided again between the pocket 311 and the guide 316. Each finger 383 of the intermediate star 380 is lowered as soon as a closure has been moved from the unloading wheel 310 into the interaction region with the intermediate star 380, and has thus simultaneously been picked up by the pocket 381, provided with the finger 383, in the intermediate star 380 and the respective pocket 311 (without the finger) in the unloading star. The finger 383 of the intermediate star 380 can be lifted again if the interaction region has been passed through and the closure is guided between the pocket 381 and the guide 385.

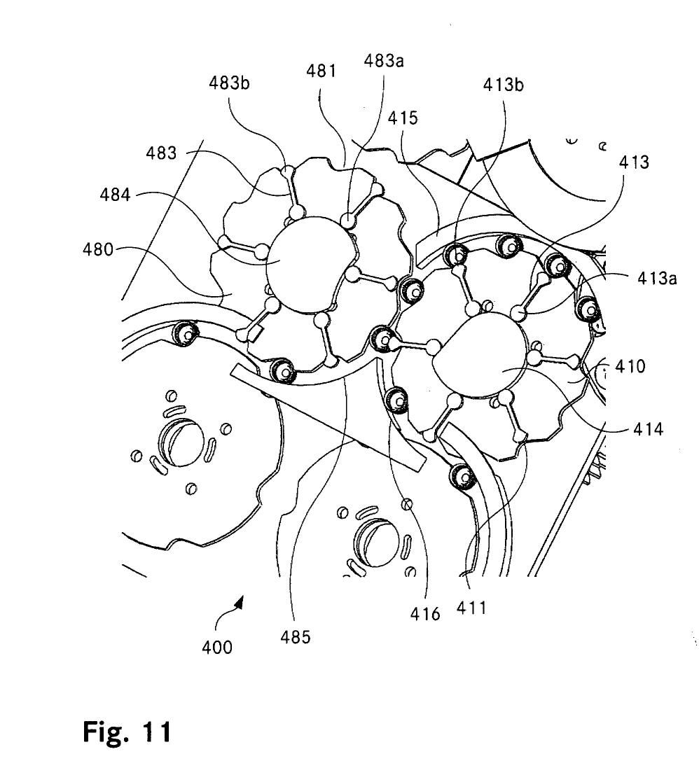

FIG. 11 shows a schematic oblique view of an alternative embodiment of an unloading star 410 and of an intermediate star 480 of a transporting away device 400. The other elements are, unless stated otherwise, of the same design as the device 300 described above in conjunction with FIGS. 7, 9 and 10. Instead of the fingers, moving tappets 413, 483 are arranged on the unloading star 410 and on the intermediate star 480. Said tappets 413, 483 can move linearly in a guide (not illustrated) which respectively runs in a radial direction, and they each comprise, at their inner end, a travel element 413a, 483a which travels on a rotationally fixed cam 414, 484, and each comprise, at their outer end, a contact element 413b, 483b for making contact with the closures which are carried along in the unloading star 410 or in the intermediate star 480.

Those pockets 411 in the unloading star 410 for workpieces which are to be transferred to the intermediate star 480 and those pockets 481 in the intermediate star 480 which are not intended to pick up any workpieces are equipped with tappets. In the interaction region, a pocket 411, 481, provided with a tappet, in the one rotary star element thus always interacts with a pocket 481, 411 without a tappet in the other rotary star element. The cam 414 is embodied in such a way that during the rotary movement of the unloading star 410 the tappets 413 are basically pulled back inward and the pockets 411 are thus released and can pick up closures. The tappets are only pressed outward by the cam 414 in the region of the outlet of the interaction region with the intermediate star 480, and thus move the closures picked up in the corresponding pockets 411 into the pockets 481 in the intermediate star 480 which lie opposite.

The tappets 483 of the intermediate star 480 are generally in their outer position. The tappets 483 of the intermediate star 480 are also pulled back radially inward only at the inlet of the interaction region owing to the shape of the cam 484, in order to permit the workpieces conveyed in the unloading star 410 to pass through the interaction region. At the outlet end of the interaction region, the tappets 483 of the intermediate star 480 are moved radially outward so that the workpiece which is picked up, or is not to be picked up, in the corresponding pocket 481 remains secured in the pocket 411, lying opposite, of the unloading star 410. Before and after the passage through the interaction region, the closures are secured in the pockets 411, 481 by the guides 415 and 416, 485 which interact with the rotary star elements.

The embodiments of the devices which are described above for feeding in and transporting away workpieces merely constitute examples. They can be modified in many aspects. For example, a large number of the elements can respectively either be arranged above the rotary stars or below them. The geometry of the various elements can be selected differently, and in particular adapted to the dimensions of the workpieces which are to be fed in and transported away.

As mentioned above, fingers or tappets can also optionally be used in the feed device. In the embodiment of the invention illustrated above, it is possible, for example, for those pockets in the intermediate star which are charged with closures by the charging star and those pockets in the loading star which are charged by the loading star to be equipped with fingers. The fingers of the intermediate star ensure that the closures firstly remain secured to the intermediate star in the inlet of the interaction region and are only discharged into the pockets in the loading star after the finger in the central part of the interaction region opens. The fingers of the loading star ensure that the closures which have already been discharged to the loading star by the first feed device remain secured in the corresponding pockets during the passage through the interaction region. The external guide which interacts with the intermediate star can be shortened to the inner surface of the guide which interacts with the loading star. The intermediate star and the loading star can be arranged on the same plane so that the closures do not have to overcome a shoulder as they pass from the intermediate star to the loading star.

In one solution with tappets, for example all the pockets in the intermediate star are each provided with a tappet. The tappets are controlled by two different fixed cam plates, i.e. every second tappet is controlled by one cam and the other tappets are controlled by the other cam. The tappets which interact with empty pockets in the intermediate star are moved radially outward at the inlet of the interaction region, firstly pulled back during the passage through the interaction region and subsequently moved out again so that the closures which are guided in the loading star during the passage through the interaction region are continuously guided between the tappet and the base of the pocket in the loading star. The other tappets, which are assigned to charged pockets in the intermediate star, are firstly pulled back and are only moved radially outward—so that the closures are moved into the pockets in the loading star—in the region of the outlet of the interaction region. Here too, the external guide which interacts with the intermediate star can be shortened to the inner surface of the guide which interacts with the loading star, and the intermediate star and the loading star can be arranged on the same plane.

The arrangement shown can be embodied as a single entity or it is possible to embody only the feed device or only the removal device in the way illustrated. The devices can also be embodied in such a way that they can interact with existing machining devices and can be retrofitted, for example, on such devices. In this case, a loading star or unloading star which is possibly already present on the machining device can continue to be used, or the feed device or the removal device can be replaced entirely.

To summarize it is to be noted that the invention provides devices for feeding in and transporting away workpieces which permit multi-track feeding and removal of workpieces and which is of simple design and suitable for high production speeds.

1. Device for feeding workpieces to a rotary table, which can rotate about a first axis, of a machining device, comprising
a) a loading star which can rotate about a second axis which is parallel to the first axis, has circumferential receptacles for the workpieces and is embodied and can be arranged in such a way that given simultaneous, synchronized rotary movement of the loading star and of the rotary table, workpieces which are held in successive receptacles in the loading star can be successively transferred into corresponding receptacles in the rotary table; characterized by
b) a first feed device which is designed in such a way that it can partially charge the loading star with workpieces; and
c) a second feed device which is arranged ahead of the first feed device in the direction of rotation of the loading star and is embodied in such a way that it can charge workpieces into receptacles in the loading star which have not been charged by the first feed device.

2. Device according to claim 1, characterized in that the second feed device comprises an intermediate star which is embodied as a rotary star and has circumferential receptacles for the workpieces and is embodied and arranged in such a way that given simultaneous, synchronized rotary movement of the intermediate star and of the loading star, workpieces which are held in intermediate star receptacles can be successively transferred into corresponding receptacles in the loading star.

3. Device according to claim 2, characterized in that the second feed device also comprises a charging device which is arranged ahead of the intermediate star and which can charge the intermediate star partially with workpieces.

4. Device according to claim 3, characterized in that the charging device is a charging star which is embodied as a rotary star and is embodied with circumferential receptacles for the workpieces and is arranged in such a way that given simultaneous, synchronized rotary movement of the charging star and of the intermediate star, workpieces which are held in receptacles in the charging star can be successively transferred into corresponding receptacles in the intermediate star.

5. Device according to claim 3, characterized in that the intermediate star and the loading star are embodied and arranged in such a way that given simultaneous, synchronized rotary movement of the intermediate star and of the loading star, respectively adjacent receptacles in the intermediate star and adjacent receptacles in the loading star can be successively moved into a mutual interaction region.

6. Device according to claim 1, characterized in that the first feed device comprises a feed star which is embodied as a rotary star, has circumferential receptacles for the workpieces and is embodied and arranged in such a way that given simultaneous, synchronized rotary movement of the feed star and of the loading star, workpieces which are held in receptacles in the feed star can be successively transferred into corresponding receptacles in the loading star.

7. Device according to claim 3, characterized in that the first feed device comprises a feed star which is embodied as a rotary star, has circumferential receptacles for workpieces and is embodied and arranged in such a way that given simultaneous, synchronized rotary movement of the feed star and of the loading star, workpieces which are held in receptacles in the feed star can be successively transferred into corresponding receptacles in the loading star, and in that in a predefined time interval T in which a number of M receptacles in the loading star interact with corresponding receptacles in the rotary table, a number of M/2 receptacles in the feed star which are charged with workpieces interact with corresponding receptacles in the loading star, wherein every second receptacle in the loading star is charged with a workpiece, and a number of M receptacles in the intermediate star interact with the loading star, wherein the charging device of the second feed device is embodied in such a way that every second receptacle of the receptacles of the intermediate star which interact with the loading star is charged with a workpiece.

8. Device according to claim 7, characterized in that the charging device is a charging star which is embodied as a rotary star, which has circumferential receptacles for the workpieces and is embodied and arranged in such a way that, given simultaneous, synchronized rotary movement of the charging star and of the intermediate star, workpieces which are held in receptacles in the charging star can be transferred successively into corresponding receptacles in the intermediate star, and in that, in the time interval T, a number of M/2 receptacles in the charging star interact with corresponding receptacles in the intermediate star, wherein adjacent receptacles in the charging star interact with the respective next but one receptacles in the intermediate star.

9. Device according to claim 1, characterized in that the receptacles in the loading star as well as, if appropriate, further rotary star elements, specifically the intermediate star, the charging star and/or the feed star, are embodied as pockets which are open at the circumference, and wherein a workpiece which is held in a pocket in a first rotary star element can be moved essentially radially into a pocket in an adjacent second rotary star element if the two pockets are located in their mutual interaction region.

10. Device according to claim 9, characterized in that the pockets are embodied in such a way that in the held state the workpieces project outward beyond a circumference of the rotary star element.

11. Device according to claim 8, characterized by external guides which are arranged and embodied radially spaced apart at the circumference from at least one of the rotary star elements, and in that the workpieces remain secured in corresponding circular segments in the pockets in the at least one rotary star element.

12. Device according to claim 11, characterized in that the rotary star elements are orientated essentially horizontally, and in that external guides are arranged both on an underside and on an upper side of the rotary star elements.

13. Device according to claim 12, characterized in that the intermediate star is arranged on a plane which is higher than the loading star.

14. Device according to claim 9, characterized in that at least one of the rotary star elements has movable fingers in order to secure the workpieces in the pockets.

15. Device according to claim 9, characterized in that the intermediate star has radially movable tappets in order to move the workpieces in the interaction region between the intermediate star and the loading star into the pockets of the loading star in a controlled fashion or to secure them in the pockets of the loading star in a controlled fashion.

16. Device according to claim 14, characterized by a cam controller for moving the fingers or the tappet.

17. Device according to claim 1, characterized in that the rotary movement of the rotary table and of the loading star as well as further rotary star elements, specifically the intermediate star, the charging star and/or the feed star, is synchronized by gearwheels which interact with one another and are connected in a rotationally fixed fashion to axles of the rotary star elements.

18. Device for transporting workpieces away from a rotary table of a machining device which can rotate about a first axis, comprising
a) an unloading star which can rotate about a second axis parallel to the first axis, which has circumferential receptacles for the workpieces and is embodied, and can be arranged, in such a way that given simultaneous, synchronized rotary movement of the rotary table and of the unloading star, workpieces which are held in successive receptacles in the rotary table can be transferred successively into corresponding receptacles in the unloading star; characterized by
b) a first removal device which is embodied in such a way that it can transport away some of the workpieces held in the unloading star from the unloading star; and
c) a second removal device which is arranged ahead of the first removal device in the direction of rotation of the unloading star and embodied in such a way that it can transport away from the unloading star, workpieces which have not been transported away by the first removal device and are held in the unloading star.

19. Device according to claim 18, characterized in that the first removal device comprises an intermediate star which is embodied as a rotary star, has circumferential receptacles for the workpieces and is embodied and arranged in such a way that given simultaneous, synchronized rotary movement of the intermediate star and of the unloading star, workpieces which are held in unloading star receptacles can be transferred successively into corresponding receptacles in the intermediate star.

20. Device according to claim 19, characterized in that the first removal device also has a pickup star which is arranged after the intermediate star, has circumferential receptacles for the workpieces and is embodied and arranged in such a way that given simultaneous, synchronized rotary movement of the intermediate star and of the pickup star, workpieces which are held in receptacles in the intermediate star can be transferred successively into corresponding receptacles in the pickup star.

21. Device according to claim 19, characterized in that the intermediate star and the unloading star are embodied and arranged in such a way that given simultaneous, synchronized rotary movement of the intermediate star and of the unloading star, respectively adjacent receptacles in the intermediate star and adjacent receptacles in the unloading star are moved successively into a mutual interaction region.

22. Device according to claim 18, characterized in that the second removal device comprises a removal star which is embodied as a rotary star, has circumferential receptacles for the workpieces and is embodied and arranged in such a way that given simultaneous, synchronized rotary movement of the removal star and of the unloading star, workpieces which are held in receptacles in the unloading star can be transferred successively into corresponding receptacles in the removal star.

23. Device according to claim 22, characterized in that the first removal star comprises an intermediate star which is embodied as a rotary star, has circumferential receptacles for the workpieces and is embodied and arranged in such a way that given simultaneous, synchronized rotary movement of the intermediate star and of the unloading star, workpieces which are held in unloading star receptacles can be transferred successively into corresponding receptacles in the intermediate star, and in that, at a predetermined time interval T in which a number of M receptacles in the unloading star interact with corresponding receptacles in the rotary table, a number of M/2 receptacles in the unloading star which are charged with workpieces interact with corresponding receptacles in the removal star, wherein a workpiece is transferred from every second receptacle in the unloading star into a corresponding receptacle in the removal star, and a number of M receptacles in the intermediate star interact with the unloading star, wherein the device is embodied and controlled in such a way that workpieces of every second receptacle in the unloading star are transferred from the unloading star into the intermediate star.

24. Device according to claim 23, characterized in that, in the time interval T, a number of M/2 receptacles in the removal star interact with corresponding receptacles in the intermediate star, wherein adjacent receptacles in the removal star interact with respective next but one receptacles in the intermediate star.

25. Device according to claim 18, characterized in that the receptacles in the unloading star, and, if appropriate, in further rotary star elements, namely in the intermediate star, in the pickup star and/or in the removal star, are embodied as pockets which are open at the circumference, wherein a workpiece which is held in a pocket in a first rotary star element can be moved essentially radially into a pocket in an adjacent, second rotary star element if the two pockets are located in their mutual interaction region.

26. Device according to claim 25, characterized in that the pockets are embodied in such a way that in the held state the workpieces project outward beyond a circumference of the rotary star element.

27. Device according to claim 26, characterized by external guides which are arranged and embodied radially spaced apart circumferentially from the rotary star elements in such a way that the workpieces remain secured in corresponding circular segments in the pockets in the rotary star elements.

28. Device according to claim 25, characterized in that the unloading star and the intermediate star have movable fingers in order to secure the workpieces in the pockets and release them in a controlled fashion.

29. Device according to claim 25, characterized in that the unloading star and the intermediate star have radially moving tappets in order to move the workpieces in the interaction region between the unloading star and the intermediate star into the pockets of the respective other rotary star element in a controlled fashion.

30. Device according to claim 28, characterized by a cam controller for moving the fingers or the tappet.

31. Machining arrangement comprising
a) a device for feeding workpieces as claimed in claim 1;
b) a machining station having a rotary table; and
c) a device for transporting away workpieces according to claim 18.
